(19) United States
(12) Patent Application Publication
(10) Pub. No.: US 2021/0056589 A1
(43) Pub. Date: Feb. 25, 2021

(54) METHOD AND SYSTEM FOR PROVIDING ADVERTISEMENTS

(71) Applicant: SHOPPERTRAK RCT Corporation, Chicago, IL (US)

(72) Inventors: Michael PAOLELLA, Lake Zurich, IL (US); Mani Kanta Reddy LANKIREDDY, Chicago, IL (US)

(21) Appl. No.: 16/549,351

(22) Filed: Aug. 23, 2019

(51) Int. Cl. G06Q 30/02; G06Q 30/06

(52) U.S. Cl. CPC G06Q 30/0261; G06Q 30/0255; G06Q 30/0271; G06Q 30/0641; G06Q 30/0267; G06Q 30/0639

(57) ABSTRACT

Aspects of the present disclosure include methods, apparatus, and systems for providing advertisements including receiving membership information associated with a shopper, retrieving shopper information based on the membership information associated with the shopper, receiving location information associated with a location of the shopper, generating the advertisement based on the shopper information and the location information, and transmitting the advertisement to be displayed on a display associated with the location of the shopper.

### BACKGROUND

Products offered by a vendor may be sold in one or more “brick-and-mortar” stores of the vendor. A customer may enter a brick-and-mortar store of the vendor and purchase products. When the customer is in the store it may be desirable to provide one or more advertisements to the customer. The advertisements may remind the customer to purchase certain routine product, offer customers items that are discounted or on sale, and/or assist in increasing vendor revenue by increasing sales. However, many stores, such as grocery stores, may offer hundreds or thousands of products, and the stores may encounter difficulties selecting the appropriate advertisement or advertisements. Therefore, improvements in delivering advertisements are desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

An aspect of the present disclosure includes a method for providing advertisements including receiving membership information associated with a shopper, retrieving shopper information based on the membership information associated with the shopper, receiving location information associated with a location of the shopper, generating the advertisement based on the shopper information and the location information, and transmitting the advertisement to be displayed on a display associated with the location of the shopper.

Some aspects of the present disclosure includes a server for providing advertisements including a memory for storing instructions and a processor configured to execute the instructions that cause the processor to perform the steps of receiving membership information associated with a shopper, retrieving shopper information based on the membership information associated with the shopper, receiving location information associated with a location of the shopper, generating the advertisement based on the shopper information and the location information, and transmitting the advertisement to be displayed on a display associated with the location of the shopper.

Certain aspects of the present disclosure includes a system including a device configured to receive membership information from a shopper identification device associated with a shopper, a detector configured to detect the device within a detection range of the detector, a display configured to display an advertisement, a memory, and a server configured to receive membership information associated with a shopper, retrieve shopper information based on the membership information associated with the shopper from the memory, receive location information associated with a location of the shopper from the detector, generate the advertisement based on the shopper information and the location information, and transmit the advertisement to the display.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for providing advertisements in accordance with aspects of the present disclosure;

FIG. 2 illustrates an example of operation in accordance with aspects of the present disclosure;

FIG. 3 illustrates an example of providing advertisements in accordance with aspects of the present disclosure;

FIG. 4 illustrates an example of a method for providing advertisements in accordance with aspects of the present disclosure; and

FIG. 5 illustrates an example of a computer system in accordance with aspects of the present disclosure.

### DETAILED DESCRIPTION

In some implementations, a system may deliver advertisements to shoppers. When a shopper enters a store, the shopper may “check-in” with the system via a device by providing a customer identification to the device. The device may be temporarily associated with the shopper. As the shopper browses through the store, one or more detectors in the store may locate the device, and identify the shopper. The one or more detectors may each be associated with one or more zones. The system may receive location information from the one or more detectors and/or shopper information, and transmit the advertisements to one or more displays in the one or more zones for the shopper to view on one or more displays.

In some aspects of the present disclosure, the advertisements may be generated by the system based on at least one of the purchase history of the shopper, preference of the shopper, inventory of the store, sales offered by the store, location of the shopper, and/or other criteria. The system may deliver the advertisements to one or more displays in the one or more zones that the shopper is in. The advertisements may remind the shopper to purchase “favorite” products, take advantage of sales and rewards, or provide directions to certain portions of the store to sales and/or offers. In other examples, the advertisements may relate to services.

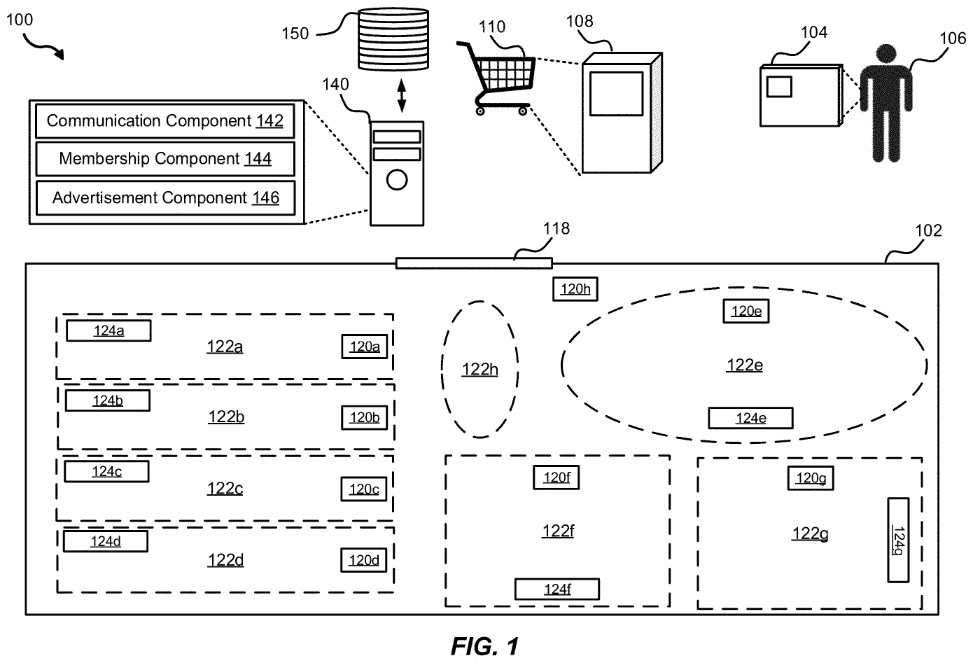

Turning now to FIG. 1, an example of an environment 100 for providing advertisements in a store 102 according to aspects of the present disclosure may include a shopper 106 intending to purchase products in the store 102. The store 102 may include an entrance 118 and one or more zones 122a-h. The store 102 may include one or more detectors 120a-h configured to detect the location of the shopper 106 by detecting the device 108 temporarily associated with the shopper 106. The store 102 may include one or more displays 124a-g. In some implementations, the shopper 106 may “check-in” before or during the shopping session by presenting a shopper identification device 104 to a device 108. The shopper identification device 104 may include shopper information associated with the shopper 106, such as name, address, shopper identification (ID) number, reward ID, organization ID, etc. In a non-limiting example, the shopper identification device 104 may be a card having a bar code representing the shopper identification of the shopper 106. In another example, the shopper identification device 104 may be a card having a magnetic strip indicating a reward ID associated with the shopper 106. In certain instances, the shopper identification device may include a radio-frequency identification (RFID) device.

In certain implementations, the device 108 may obtain the shopper information associated with the shopper 106 from the shopper identification device 104. The device 108 may allow the shopper 106 to be tracked as the shopper 106 goes through the store 102. In one non-limiting example, the device 108 may be attached to an optional cart 110. The optional cart 110 may be a shopping basket. The shopper 106 may go through the store 102 with the optional cart 110 having the device 108 attached. The device 108 may be a wireless device, a handheld device, a cellular phone, a tablet computer, a personal digital assistant, a scanner, or other portable devices capable of wireless communications. The device 108 may be configured to communicate via RF communication, wired communication, near-field communication (NFC), and other communication mechanisms. In an optional implementation, the shopper 106 may input the shopper information into the device 108.

Still referring to FIG. 1, in some aspects, the environment 100 may include a server 140 communicatively coupled with an optional data repository 150 for providing the advertisements discussed herein. In an implementation, the server 140 may be a computer device having a processor and a memory storing computer-executable instructions to perform the functions described herein, and the data repository 150 may be a memory device storing data and/or computer-readable instructions associated with the functions described herein. The server 140 may include a communication component 142 for communicating with the one or more detectors 120a-h and/or the one or more displays 124a-g. The server 140 may include a membership component 144 for retrieving shopper information associated with the shopper 106. Examples of shopper information may include the purchase history of the shopper 106, the preference indicated by the shopper 106, etc. For example, the communication component 142 may include one or more modems operable according to one or more technologies (e.g., wireline and/or wireless), and the authentication component 144 may be a security processor and/or computer-readable instructions executed by a processor and include particular instructions for executing authentication algorithms described herein. Also, more specifically, the optional data repository 150 may be configured to store information such as the membership information, the shopper information, the layout of the store 102, the inventory information of the store 102, and/or other information relevant to generating the advertisements. In some implementations, the server 140 may be in the store 102 or away from the store 102.

During operation, in certain aspects, the shopper 106 may intend to purchase products from the store 102. The shopper 106 may present the shopper identification device 104 to the device 108. After receiving the membership information via the shopper identification device 104, the device 108 may be temporarily associated with the shopper 106 while the shopper 106 browses the store 102. The device 108 may be attached to the optional cart 110 used by the shopper 106. After entering the store 102 via the entrance 118, the detector 120h may detect device 108 (e.g., attached to the operation cart 110 or held by the shopper 106) temporarily associated with the shopper 106. The detector 120h may transmit first location information to the server 140 to indicate that the shopper 106 has entered the stored. In response to receiving the first location information, the membership component 144 of the server 140 may retrieve shopper information associated with the shopper 106, such as the purchase history, preferences, wish list, gift ideas, add-ons, warranty information, or other information relevant to the shopper 106. In a non-limiting example, the shopper identification device 104 and/or the device 108 may be a mobile device belonging to the shopper 106.

Next, in certain implementations, the shopper 106 may browse the store 102. In one example, the shopper 106 may browse the store 102 with the optional cart 110 having the device 108 attached. The detectors 120a-h may detect the location of the shopper 106 by detecting the device 108 as the shopper 106 moves among the one or more zones 112a-h. In one example, the shopper 106 may move from the entrance 118 to approximately the zone 122b. The detector 120b may detect the location of the shopper 106 and/or the device 108. The detector 120b may transmit second location information to the server 140 indicating that the shopper 106 is approximately near the zone 122b. In response to receiving the second location information from the detector 120b, the advertisement component 146 may generate a first advertisement based on the shopper information and location information (e.g., second location information). The first advertisement may include one or more products in the zone 122b. The one or more products and/or services in the first advertisement may be on sale for a discounted price. The first advertisement may include services offered in the zone 122b that the shopper 106 has shown interests (e.g., marked as favorite, added to wish-list, previously purchased). The server 140 may transmit the first advertisement to the display 124b in the zone 122b to be displayed to the shopper 106.

In some aspects of the present disclosure, the location information may be transmitted by the one or more detectors 120a-h. In an aspect, a layout of the store 102 may be stored in the server 140 and/or the optional data repository 150. The layout may indicate the locations of the one or more detectors 120a-h. For example, the layout may indicate that the detector 120a is in the zone 122a, the detector 120b is in the zone 122b, the detector 120c is in the zone 122c, the detector 120d is in the zone 122d, the detector 120e is in the zone 122e, the detector 120f is in the zone 122f, the detector 120g is in the zone 122g, the detector 120h is approximately near the entrance 118. When one of the one or more detectors 120a-h transmits the location information to the server 140, the server may be able to identify the location of the device 108 based on the particular detector that transmitted the location information. For example, if the detector 120f transmitted the location information, the server 140 may identify the shopper 106 (and the device 108) to be in or near the zone 122f based on the location of the detector 120f. In another example, the location information may specify that the shopper 106 and the device 108 are in the zone 122f.

In other aspects, the shopper 106 may browse the store 102 by moving to a new zone, e.g., the zone 122e. The detector 120e may detect the device 108 temporarily associated with the shopper 106. The detector 120e may transmit third location information to the server 140 indicating that the shopper 106 is approximately near the zone 122e. In response to receiving the third location information from the detector 120e, the advertisement component 146 of the server 140 may generate a second advertisement based on the shopper information and third location information. For example, the server 140 may transmit the second advertisement to the display 124e. The display 124e may display the second advertisement. The second advertisement may include products and/or services on sale in a different location than the zone 122e, such as the zone 122g. The second advertisement may include direction from the zone 122e to the zone 122g.

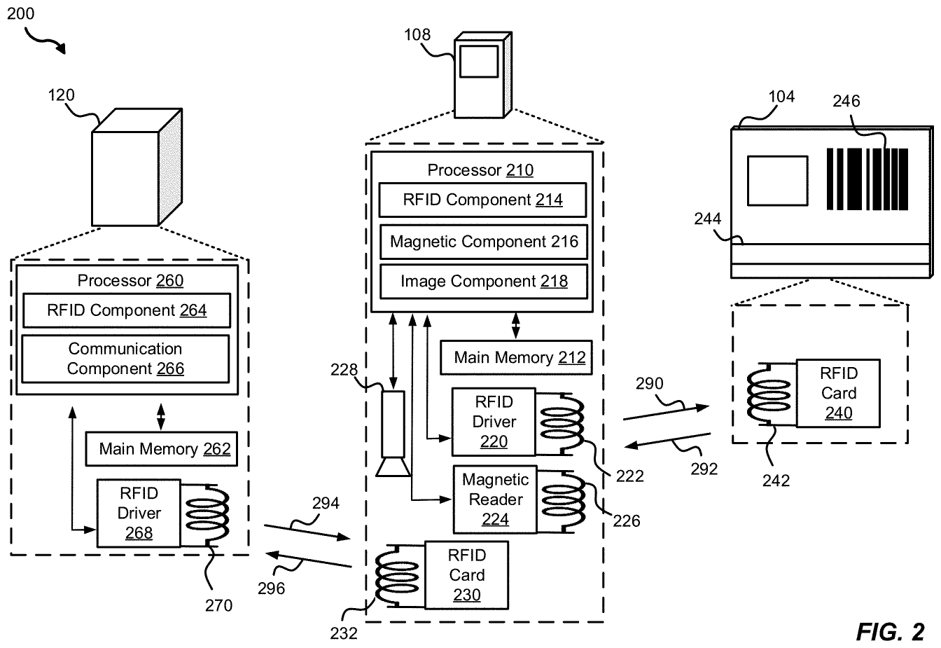

Referring to FIG. 2, and continuing to reference FIG. 1, an example of the device 108 for receiving membership information from the shopper identification device 104 may include a processor 210 that executes instructions stored in a main memory 212 for performing the advertisement generation functions described herein. The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In some implementations, the device 108 may receive the membership information via a radio frequency identification (RFID) signal. The processor 210 may include a RFID component 214 that causes the RFID driver 220 to transmit a RFID membership interrogation signal 290 via a transmitting coil 222, to a RFID card 240 of the shopper identification device 104. The RFID driver 220 may energize the transmitting coil 222 to transmit the RFID membership interrogation signal 290. The transmitting coil 222 may include one or more inductors that transmit or receive electromagnetic signals.

In certain examples, the shopper identification device 104 may include a response coil 242 configured to receive the RFID membership interrogation signal 290 from the transmitting coil 222. The shopper identification device 104 may include the RFID card 240 configured to receive the RFID membership interrogation signal 290 and respond with a RFID membership response signal 292 including the membership information of the shopper 106.

During operation, in some implementations, the processor 210 and/or the RFID component 162 may cause the RFID driver 220 to transmit the RFID membership interrogation signal 290 via the transmission coil 222. The response coil 242 of the shopper identification device 104 may receive the RFID membership interrogation signal 290. An electrical current generated from the reception of the RFID membership interrogation signal 290 may be provided to the RFID card 240 for electrical energy. In response to receiving the electrical current and/or the RFID membership interrogation signal 290, the RFID card 240 may transmit, via the response coil 242, a RFID membership response signal 292 to the RFID driver 220 of the device 108. In response to receiving the RFID membership response signal 292, the RFID component 214 may extract the membership information of the shopper 106 from the RFID membership response signal 292.

In some instances, the device 108 may receive the membership information by scanning a magnetic strip 244 of the shopper identification device 104 via a magnetic reader 224 and an interrogating coil 226. In response to scanning the magnetic strip 244 of the shopper identification device 104, the magnetic component 216 may extract the membership information of the shopper 106.

In other implementations, the device 108 may receive the membership information by detecting a visual code 246 (e.g., bar code, QR code, etc.) of the shopper identification device 104 via a photodetector 228. In response to detecting the visual code 246 of the shopper identification device 104, the image component 218 may extract the membership information of the shopper 106. Other means of obtaining membership information (e.g., manual entry by the shopper 106) are possible.

In certain aspects of the present disclosure, the detector 120 may detect the device. The detector 120 may include a processor 260 and a memory 262 communicatively coupled with the processor 260. The processor 260 may include a RFID component 264 that receives the membership information of the shopper 106. The processor 260 may include a RFID driver 268 and an interrogating coil 270 configured to transmit and receive RFID signals. The device 108 may include a RFID card 230 and/or a response coil 232 configured to transmit and receive RFID signals.

During operation, in some implementations, the processor 260 and/or the RFID component 264 may cause the RFID driver 268 to transmit a RFID membership interrogation signal 294 via the interrogating coil 270. The response coil 232 of the device 108 may receive the RFID membership interrogation signal 294. An electrical current generated from the reception of the RFID membership interrogation signal 294 may be provided to the RFID card 230 for electrical energy. In response to receiving the electrical current and/or the RFID membership interrogation signal 294, the RFID card 230 may transmit, via the response coil 232, a RFID membership response signal 296 to the RFID driver 268 of the detector 120. In response to receiving the RFID membership response signal 296, the RFID component 264 may obtain the membership information of the shopper 106 from the RFID membership response signal 296.

The detector 120 may detect the device 108 when the device is within a detection range of the detector 120. For example, the detector 120 may detect the device 108 when the device 108 is within 1 meter (m), 2 m, 3 m, 4 m, 5 m, 10 m, or other distances that the RFID driver 268 is able to receive the RFID membership response signal 296.

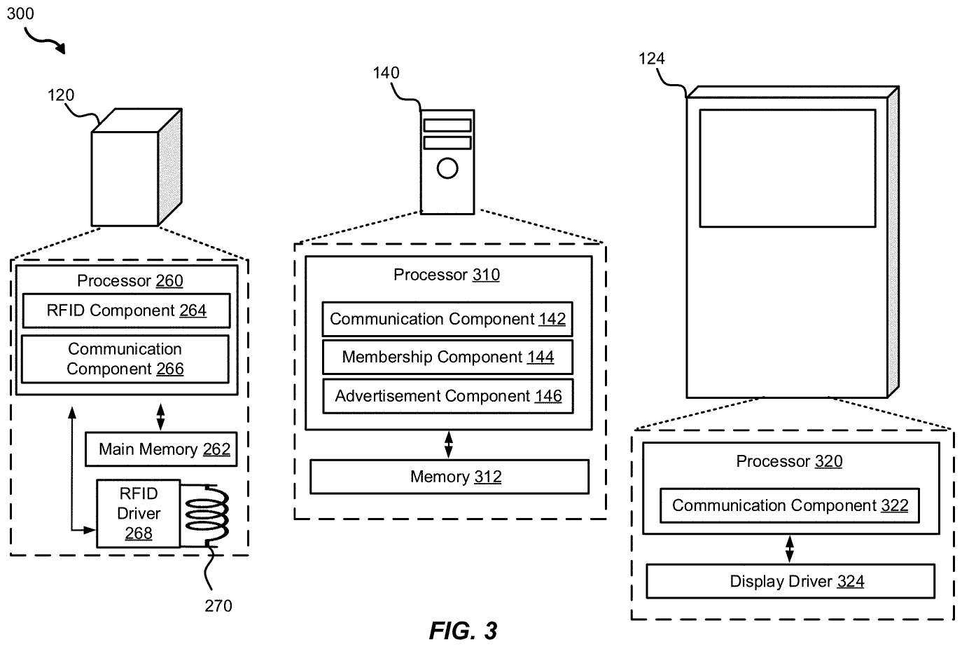

Turning now to FIG. 3, and continuing to reference FIG. 1, after the detector 120 obtains the membership information of the shopper 106 from the device 108 associated with the shopper 106, the detector 120 may utilize a communication component 266 to transmit the membership information to the server 140. In some implementations, the membership component 144 may utilize the membership information to obtain shopper information associated with the shopper 106. The shopper information may include at least one of the purchase history of the shopper 106, preference of the shopper 106, wish list of the shopper 106, inventory of the store 102, sales offered by the store 102, warranty purchased by the shopper 106, add-ons to the products previously purchased by the shopper 106, etc. The shopper information may be stored in the memory 312 or the optional data repository 150.

Next, in an example, the advertisement component 146 may generate the advertisement based on the shopper information and/or the location of the shopper 106 within the store 102. The location of the shopper 106 may be optionally provided by the detector 120. For example, the advertisement may include products on the wish list of the shopper 106 near the location of the shopper 106 (e.g., one of the one or more zones 122).

In one example of the present disclosure, the server 140 may maintain a product relevance rating for each item associated with the shopper 106 (e.g., purchased by the shopper 106 previously, on the wish list of the shopper 106, etc.). The product relevance rating may indicate the interest of the shopper 106 toward the product. In some instances, the product relevance rating may be incremented when the shopper 106 purchases the product. As the shopper 106 purchases the product with higher frequency, the product relevance rating may increase accordingly. The advertisement component 146 of the server 140 may utilize the product relevance ratings associated with the shopper 106 to determine the advertisement to be displayed. For example, the advertisement component 146 may generate an advertisement for a product that has the highest produce relevance rating. In other examples, the advertisement component 146 may generate an advertisement for a product that is similar to the products previously purchased by the shopper 106.

In another aspect of the present disclosure, the server 140 may receive the purchase history of the shopper 106 at a different store (e.g., a different store owned by the same owner, a different store owned by different owners, etc.).

In certain variations, the communication component 142 of the server 140 may transmit the advertisement to the display 124. For example, a communication component 322 of a processor 320 of the display 124 may receive the advertisement. In response to receiving the advertisement, the display 124 may display the advertisement to the shopper 106. The display 124 may be disposed at the beginning of the aisles, in the middle of the aisles, or at the end of the aisles for example.

In optional implementations, the communication component 142 of the server 140 may notify one or more employees (e.g., clerks, not shown) in the store 102 that the shopper 106 may need assistance and that the shopper 106 is near the detector 120. For example, the one or more employees may approach the location of the shopper 106 and offer assistance to the shopper 106.

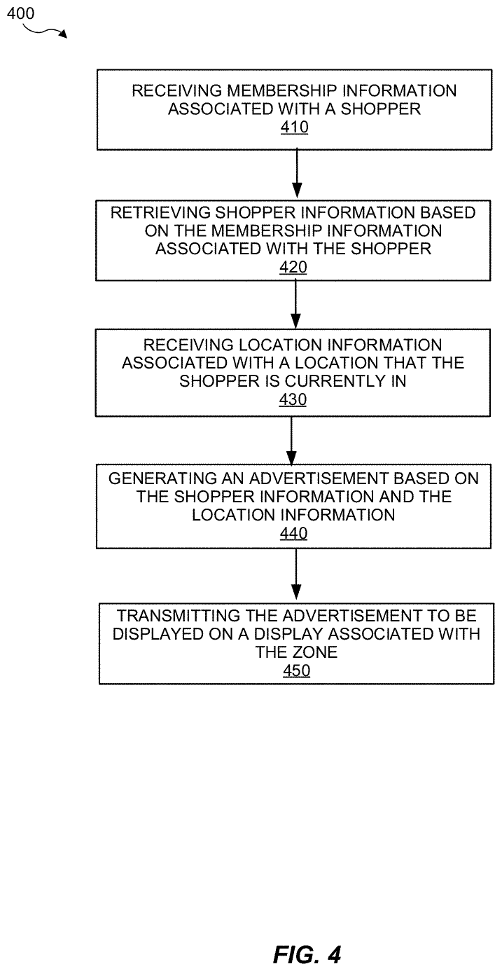

Referring to FIG. 4, an example method 400 for generating an advertisement may be performed by the processor 310, the memory 312, the communication component 142, the membership component 144, and the advertisement component 146 of the server 140.

At block 410, the method 400 may receive membership information associated with a shopper. For example, the communication component 142 of the server 140 may receive the membership information transmitted by the communication component 266 of one of the one or more detectors 120a-h. The one of the one or more detectors 120a-h may detect the device 108 temporarily associated with the shopper 106 when the shopper 106 (along with the device 108) approaches within a detection distance of the one of the one or more detectors 120a-h. The one of the one or more detectors 120a-h may receive the membership information from the device 108.

At block 420, the method 400 may retrieve shopper information based on the membership information associated with the shopper. For example, the membership component 144 of the server 140 may retrieve the shopper information based on the membership information associated with the shopper 106. The membership component 144 may retrieve the shopper information from the optional data repository 150 or the memory 312. The shopper information may include at least one of the purchase history of the shopper 106, preference of the shopper 106, wish list of the shopper 106, inventory of the store 102, sales offered by the store 102, warranty purchased by the shopper 106, add-ons to the products previously purchased by the shopper 106, etc. In some aspects, the shopper information may include products (e.g., 10, 20, 30, 40, or 50) having the highest product relevance ratings.

At block 430, the method 400 may receive location information associated with a location of the shopper. For example, the communication component 142 of the server 140 may receive location information transmitted by the communication component 266 of one of the one or more detectors 120a-h. The location information may include an indication that the shopper 106 is in the zone 122b. In a non-limiting example, the server 140 may be able to identify the zone that the shopper 106 is in based on which detector 120 transmitted the location information. In another example, the server 140 may be able to identify the location of the shopper 106 based on the content of the location information (e.g., location information specifying which zone the shopper 106 is in).

At block 440, the method may generate an advertisement based on the shopper information and the location information. For example, the advertisement component 146 of the server may generate an advertisement that includes products in the zone 122b that the shopper 106 previously purchased. The products in the advertisement may be on sale for a discounted price. The advertisement may include services offered in the zone 122b that the shopper 106 has shown interests (e.g., marked as favorite, added to wish-list).

At block 450, the method may transmit the advertisement to be displayed on a display associated with the location of the shopper. For example, the communication component 142 of the server 140 may transmit the advertisement to the display 124b in the zone 122b to be displayed to the shopper 106.

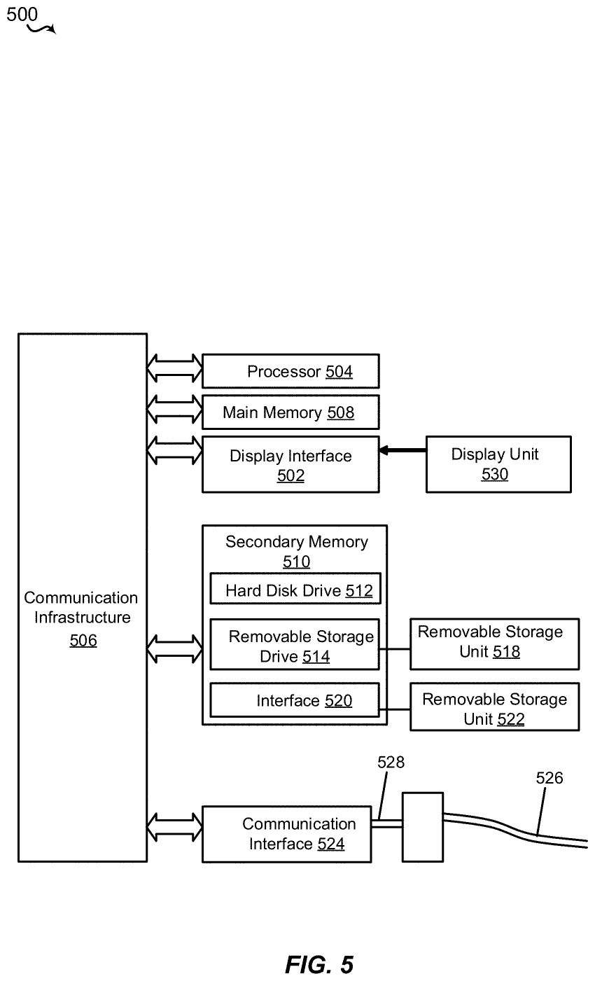

Aspects of the present disclosures, such as the device 108 and/or the server 140, may be implemented using hardware, software, or a combination thereof and may be implemented in one or more computer systems or other processing systems. In an aspect of the present disclosures, features are directed toward one or more computer systems capable of carrying out the functionality described herein. An example of such a computer system 500 is shown in FIG. 5. The device 108 and/or the server 140 may include some or all of the components of the computer system 500.

The computer system 500 includes one or more processors, such as processor 504. The processor 504 is connected with a communication infrastructure 506 (e.g., a communications bus, cross-over bar, or network). The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. Various software aspects are described in terms of this example computer system. After reading this description, it will become apparent to a person skilled in the relevant art(s) how to implement aspects of the disclosures using other computer systems and/or architectures.

The computer system 500 may include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512, and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data. In some examples, one or more of the main memory 508, the secondary memory 510, the removable storage unit 518, and/or the removable storage unit 522 may be a non-transitory memory.

Alternative aspects of the present disclosures may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, an RF link and/or other communications channels. In this document, the terms “computer program medium” and “computer usable medium” are used to refer generally to media such as a removable storage unit 518, a hard disk installed in hard disk drive 512, and signals 528. These computer program products provide software to the computer system 500. Aspects of the present disclosures are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features in accordance with aspects of the present disclosures, as discussed herein. In particular, the computer programs, when executed, enable the processor 504 to perform the features in accordance with aspects of the present disclosures. Accordingly, such computer programs represent controllers of the computer system 500.

In an aspect of the present disclosures where the method is implemented using software, the software may be stored in a computer program product and loaded into computer system 500 using removable storage drive 514, hard drive 512, or communications interface 520. The control logic (software), when executed by the processor 504, causes the processor 504 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A method of generating an advertisement in a store, comprising:
receiving membership information associated with a shopper;
retrieving shopper information based on the membership information associated with the shopper;
receiving location information associated with a location of the shopper;
generating the advertisement based on the shopper information and the location information; and
transmitting the advertisement to be displayed on a display disposed fixedly at the location of the shopper in the store.

2. The method of claim 1, wherein generating the advertisement further comprises generating the advertisement based on at least one of a purchase history of the shopper, a preference of the shopper, a wish list of the shopper, inventory of the store, a sales offer, a warranty purchased by the shopper, or an add-on to a product previously purchased by the shopper.

3. The method of claim 1, wherein the advertisement comprises a sales offer near the location of the shopper.

4. The method of claim 1, wherein the advertisement comprises directions to a product in the store.

5. The method of claim 1, further comprises transmitting a notification to an employee to assist the shopper, wherein the notification includes the location of the shopper.

6. The method of claim 1, wherein the shopper information comprises a plurality of product relevance ratings associated with a plurality of products.

7. The method of claim 6, further comprises updating the plurality of product relevance ratings of the shopper information based on purchases made by the shopper.

8. A server for generating an advertisement in a store, comprising:
a memory for storing instructions; and
a processor configured to execute the instructions that cause the processor to perform the steps of:
receiving membership information associated with a shopper;
retrieving shopper information based on the membership information associated with the shopper;
receiving location information associated with a location of the shopper;
generating the advertisement based on the shopper information and the location information; and
transmitting the advertisement to be displayed on a display disposed fixedly at the location of the shopper in the store.

9. The server of claim 8, wherein generating the advertisement further comprises the processor executing the instructions that cause the processor to generate the advertisement based on at least one of a purchase history of the shopper, a preference of the shopper, a wish list of the shopper, inventory of the store, a sales offer, a warranty purchased by the shopper, or an add-on to a product previously purchased by the shopper.

10. The server of claim 8, wherein the advertisement comprises a sales offer near the location of the shopper.

11. The server of claim 8, wherein the advertisement comprises directions to a product in the store.

12. The server of claim 8, wherein the processor is further configured to execute the instructions that cause the processor to perform the step of transmitting an notification to an employee to assist the shopper, wherein the notification includes the location of the shopper.

13. The server of claim 8, wherein the shopper information comprises a plurality of product relevance ratings associated with a plurality of products.

14. The server of claim 13, wherein the processor is further configured to execute the instructions that cause the processor to perform the step of updating the plurality of product relevance ratings of the shopper information based on purchases made by the shopper.

15. A system of a store, comprising:
a device configured to receive membership information from a shopper identification device associated with a shopper;
a detector configured to detect the device within a detection range of the detector;
a plurality of displays configured to display an advertisement in the store;
a memory; and
a server configured to:
receive membership information associated with a shopper;
retrieve shopper information based on the membership information associated with the shopper from the memory;
receive location information associated with a location of the shopper from the detector;
generate the advertisement based on the shopper information and the location information; and
transmit the advertisement to a display of the plurality of displays, wherein the display is disposed fixedly at the location of the shopper.

16. The system of claim 15, wherein generating the advertisement further comprises generating the advertisement based on at least one of a purchase history of the shopper, a preference of the shopper, a wish list of the shopper, inventory of the store, a sales offer, a warranty purchased by the shopper, or an add-on to a product previously purchased by the shopper.

17. The system of claim 15, further comprises a shopping cart, wherein the device is detachably coupled to the shopping cart.

18. The system of claim 15, wherein the shopper information comprises a plurality of product relevance ratings associated with a plurality of products.

19. The system of claim 15, wherein the shopper information comprises a plurality of product relevance ratings associated with a plurality of products.

20. The system of claim 19, wherein the server is further configured to perform the step of updating the plurality of product relevance ratings of the shopper information based on purchases made by the shopper.
